(19) United States
(12) Patent Application Publication
(10) Pub. No.: US 2007/0012080 A1
(43) Pub. Date: Jan. 18, 2007

(54) Method for ameliorating sodicity in soil

(76) Inventor: John Ashworth, Edmonton (CA)

Correspondence Address: JOHN ASHWORTH, 9752-89 AVE., EDMONTON, AB, T6E-2S2, CA

(21) Appl. No.: 11/428,557

(22) Filed: Jul. 4, 2006

Related U.S. Application Data
(60) Provisional application No. 60/698,071, filed on Jul. 12, 2005.

(51) Int. Cl. C05B 7/00

(52) U.S. Cl. 71/32

(57) ABSTRACT

I have shown that: (1) Sodic soils, sodic materials, or mixtures of soil and sodic materials having high SAR values that are detrimental to soil performance and which may also exceed published regulatory threshold levels can, by means of treatment with chelating agents that cause release of calcium and magnesium, be ameliorated so that SAR values fall to non-detrimental levels, without at the same time causing unsuitable increase in salinity (EC). (2) Permeability of sodic soil markedly improved after treatment with chelating agents. (3) Using the synthetic chelating agent EDTA, the low SAR values of treated sodic materials were persistent. (4) EDTA added to sodic, alkaline drilling cuttings did not decompose during a test using conditions simulating actual drilling. (5) Sodic soil treated with EDTA was non-toxic in the Microtox™ bioassay.

### CROSS-REFERENCE TO RELATED APPLICATIONS

This application claims the benefit of provisional patent application Ser. No. US60/698,071 filed 2005 Jul. 12 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to a method for improving soil adversely affected by sodium, by means of adding a chelating agent to said soil.

2. Prior Art

It is well known that soils containing excessive sodium can thereby be made unsuitable for crop production, landscaping or engineering purposes, due to two separate adverse properties:
(a) salinity, often expressed in terms of the soil's electrical conductivity (EC), and
(b) sodicity, often expressed in terms of the soil's sodium adsorption ratio (SAR).

A significant percentage of the world's agricultural land base is adversely affected by salinity and sodicity, due to either naturally occurring sodium contamination or man-made contamination arising from activities such as mining, petroleum extraction, dam construction and irrigation.

Effects of Salinity and Sodicity on Plant Growth and Soil Quality:

(a) Salinity (high EC) directly affects plant growth by hindering or even preventing root uptake of water which must occur against an osmotic pressure gradient. The greater the concentration of dissociated, ionized salts in a soil's pore water, the greater the water's charge-carrying capacity and hence the higher the soil's EC.
The EC is often measured in soil extracts, derived by filtering a paste of water-saturated soil (a “saturated paste”). It is expressed in units such as deciSiemens per meter (dS/m). Below EC=2 dS/m, soils are considered non-saline and few plant species are affected, but at salinity levels above 12 dS/m most plant species cannot grow.
(b) Sodicity (high SAR) can cause soil plasticity, leading to difficulties in soil cultivation and to slow rates of water infiltration and drainage. These effects occur with sodic soils containing much clay, and in soils with naturally-occurring sodic subsoils such as solonietzic soil. SAR values in saturated paste extracts of non-sodic soils are usually less than 1 SAR unit. Sodicity problems typically arise when SAR values exceed 6-10 units, depending on clay content. The SAR is a measure of the influence of sodium Na ions (positively charged cations) in the pore water, relative to that of calcium Ca and magnesium Mg cations. The SAR value is calculated using the equation:
   SAR=[Na⁺]/sqrt{[Ca²⁺]+[Mg²⁺]} (1)
   where [Na⁺] etc. are cation concentrations in a filtrate of a saturated soil paste. Na cations are monovalent (carrying a single positive charge) whereas Ca and Mg cations are divalent (two charges). In naturally occurring sodic soils, the SAR is correlated with the percentage of cation exchange sites, on clay and organic matter, occupied by sodium cations.

As a result of these adverse effects, environmental guidelines are in place in various jurisdictions, regulating permitted levels of EC and SAR in soil and subsoil. For example, the two parameters are regulated in current guidelines for drilling waste disposal on soil in western Canada (e.g. AEUB, 1996).

Remedial Treatment of Sodium-Affected Soils.

Traditional ameliorants are salts such as calcium sulfate (gypsum), calcium nitrate, calcium chloride, and magnesium sulfate (Epsom salts) which dissolve in soil pore water to yield Ca or Mg cations that are dissociated (widely separated) in solution from attendant negatively charged anions. Alternatively, acids have been applied such as sulfuric acid, which reacts with calcium or magnesium carbonate (forms of lime present in alkaline soil) to release Ca or Mg cations in situ, again dissociated from the negatively charged anion (sulfate).

Such approaches were developed many years ago (Richards, 1954) and remain in widespread use (e.g. Naidu et al. 1993; Ashworth et al., 1999).

Said ameliorants are applied in order to increase the concentration of Ca or Mg cations in the soil's pore water thus lowering the soil's sodicity (the SAR value, obtained using Eqn. 1 above).

Unfortunately as an unavoidable and inconvenient side effect, the salinity (EC) of the treated soil increases, due to the charged Ca or Mg cations (and related anions) either added or produced in situ, thus possibly damaging plant growth as well as potentially exceeding EC guideline thresholds.

Chelating Agents:

Chelating agents (also known as complexing or sequestering agents) form stable complexes with many cations, in which the cation is enveloped by the molecular structure of the chelating agent, which serves as the anion. Such agents have been used to deliver to plant roots micronutrients such as copper, manganese and iron, which otherwise can precipitate out or be adsorbed to soil and thus made unavailable to plants (e.g. Allison and Hewitt, U.S. Pat. No. 2,813,014). Chelated iron has been used as an ameliorant for acidic soil (Sasaki and Mitsunaga, J.P. # 89,197,591).

Chelating agents have also been used as sequestering agents to remove toxic metals such as lead and cadmium from contaminated soil (e.g. Redwine et al., U.S. Pat. No. 6,210,078). They have also been used to sequester pollutants in soil and render them harmless through reaction with a colloidal matrix (Newton, E.P. # 756,904).

Chelating agents were used in pot experiments by Panov et al. (Dokl. Vses. Akad. S-kh. Nauk im. V.I. Lenina, 12: 2-4, 1982) to improve plant uptake of micronutrients. An abstract of their work (Chemical Abstracts 99: 174785u, 1983) refers to increased solubility of Ca compounds and improved quality of irrigation water.

Chelating agents have been added to fluids used for well-drilling in the petroleum industry so as to bring insoluble barium compounds into solution, as well as for affecting the properties of bentonite clay used in said fluids. Spent fluids may afterwards be disposed of to soil, but the resulting presence of chelating agents in the fluid-treated soil is incidental and not intentionally for the purpose of affecting the properties of said soil.

Chelating agents have been used to treat soils for well over half a century (Chaberek & Martell 1959), and the electrically neutral nature of chelated cations has also long been known (Ayres 1968). However, despite the length of this period of related knowledge, the applicant has not uncovered any reference to the objects of (i) amelioration of soil SAR, in conjunction with (ii) limiting soil EC increase; nor indeed any direct reference to either individual object.

This combination of low SAR along with low EC (improving sodicity as well as curbing salinity increase) has been very difficult to achieve in much previous work (e.g. Ashworth & Webster 2004) using traditional ameliorants that contain, or generate in situ, soluble Ca or Mg.

On the basis of art cited above, and other published work on chelating agents considered but not cited, in the opinion of the applicant the possibility does not obviously follow that said agents can be used to improve soil quality by releasing Ca and Mg cations to counter sodicity, while at the same time largely avoiding undesirable increase in salinity.

### OBJECTS AND ADVANTAGES

The object of the invention is to use chelating agents to release essentially insoluble Ca and Mg from sodic soil, thereby ameliorating problems caused by high sodicity (SAR). A concomitant object and advantage of the invention is that release of Ca and Mg cations in chelated form leads to much smaller increases in soil salinity (EC) than traditional met hods which instead involve adding amendments that generate dissociated Ca or Mg cations.

Further objects and advantages of the invention will become apparent from consideration of the following findings:

(a) Adding calcium chloride to a loam soil increased soluble Ca in the filtrate from a saturated paste by 900 milligrams per liter (mg/L) causing filtrate EC to increase by more than 5 dS/m; whereas, adding the chelating agent ethylenediamine tetraacetic acid (EDTA) released 1,000 gm/L of Ca causing an EC increase of less than 2 dS/m.

(b) A naturally sodic soil, originally yielding a saturated paste filtrate with an SAR value of 11.0 and an EC of 0.7 dS/m had an SAR value of 4.7 and an EC of 1.5 dS/m after treatment with the chelating agent citric acid at the rate of 2 g acid per L of soil.

(c) A saturated paste of the above mixture of sodic soil and citric acid when filtered under vacuum yielded approximately 1 mL of filtrate per minute, whereas a saturated paste of said sodic soil untreated with, citric acid yielded less than 0.1 mL per minute. This order of improvement in filtration rate of saturated pastes was typical of all soils following treatment with a chelating agent.

(d) Chelating agents were applied at the rate of 1 kg per square meter to the surface of small plots on a sodic area (SAR=8 approx.) in a cultivated field at the Parkland Conservation Farm (=www.parklandconservationfarm.com) near Mundare, Alberta in October 2005, then left over winter. Replicated water infiltration tests done in May 2006 indicated that untreated soil was in the “slow” class with a mean water infiltration rate of 0.25 cm/h, statistically significantly lower than the rate for adjacent plots given a chelating agent in the form of malic acid (0.95 cm/h, “moderately slow”) or EDTA (4.91 cm/h, “moderate”). Improved water infiltration can be expected to improve crop yield.

(e) A mixture of sodic waste and soil (with SAR=7.5 and EC=0.8 dS/m) when treated with EDTA at the rate of 0.5 g per L of waste had an SAR=3.7 and EC=1.7 dS/m. Treatment with sulfuric acid at an equivalent rate was less effective in terms of both improving sodicity and curbing salinity, resulting in an SAR=5.1 and EC=2.7 dS/m.

(f) In a pilot-scale test in June 2006 on a drilling lease near Edson, Alberta 24 kg of the chelating agent EDTA was mixed by backhoe into a previously made blend of approximately five cubic meters of lease subsoil (SAR=0.2) with one cubic meter of a sodic, alkaline drilling waste material (SAR=19 and pH=10). Several hundred cubic meters of this waste was generated as a result of drilling for natural gas at the site. The EDTA-treated 5:1 blend had an SAR of 1.5 whereas a control, untreated blend had an SAR of 2.6 which, though not very high, nevertheless exceeded the current provincial guideline for increase in SAP following drilling waste disposal.

(g) In a parallel pilot-scale test, the same quantity of EDTA was mixed by backhoe with one cubic meter of the same, raw drilling waste. An hour was deliberately allowed to elapse before blending the treated waste with 5 cubic meters of lease subsoil. The result obtained (SAR=1.2) on analyzing the blend thus treated indicated that EDTA had not been inactivated by the one hour of contact with the alkaline waste material.

(h) A mixture of sodic waste and soil, treated with EDTA at the rate of 30 g per L of waste, was found to be completely non-toxic using the Microtox™ bioassay, the standard bioassay test in drilling waste disposal in Alberta, Canada (AEUB 1996). This finding is consistent with literature on toxicity of EDTA, e.g. http://ptcl.chem.ox.ac.uk/˜hmc/hsci/chemicals/EDTA.html

(i) EDTA was added to 2 L portions of alkaline drilling cuttings at the rate of 8 g/L. One portion of EDTA-treated cuttings received no further treatment, while a replicate portion was subjected to a “hot-roll” test at 80 degrees Celsius for 16 h, to simulate downhole drilling conditions. Sub-samples (75 mL) of untreated cuttings and of the regular and the hot-rolled EDTA-treated cuttings were blended with 150 mL of silty soil (SAR=0.5). A saturated paste of each blend was then made and the filtrate analyzed for SAR and residual EDTA. The blend of soil and untreated cuttings had an SAR=4.8, whereas the SAR was 2.4 using regular EDTA-treated fluid and 2.2 with hot-rolled EDTA-treated fluid. The latter two filtrates both had 300 mg/L approximately of EDTA.

The above results indicate that EDTA was not degraded during the hot-roll process, suggesting that it could be used as an additive in drilling fluids to reduce the sodicity of the dulling waste thus produced. This pre-treatment with EDTA might avoid problems with SAR during waste disposal.

(j) To test the stability of mixtures of sodic soil and chelating agents, citric acid (1.5 g) or EDTA (1.5 g) was added to 450 portions of a moist blend of a sodic drilling waste and a silty soil, having SAR=6.0 and EC 17 dS/m. (The rate of addition corresponded to 20 kg of chelating agent per cubic meter of drilling waste.) The mixtures were stored at room temperature in glass jars, keeping the screw-cap one quarter turn loose. De-ionized water was added from time to time to maintain the required weight and moisture content. Sub-samples (50 g) were removed at intervals and saturated pastes made, filtered and analyzed.

The mixture treated with citric acid had an SAR=4.3 and EC=2.3 dS/m initially but after 10 days' storage had SAR=5.3 and EC=1.8 dS/m, then after 2 months was indistinguishable from the initial, untreated material with SAR=6.0 and EC 1.7 dS/m, as already stated.

In contrast, the mix given EDTA had an initial SAR of 2.5 and EC of 3.2 dS/m, values that were maintained in five subsequent samplings within experimental uncertainty; and which had still not changed at the time of submitting this application, after more than ten months' storage.

Since the rate of a biological process like degradation typically doubles with a 10 degree Celsius rise in temperature, the result suggests that the SAR and EC of EDTA-treated material would not alter for many years in cold subsoil. Such long-term stability is often mentioned in the literature on EDTA.

(k) A loamy sand soil containing no measurable natural lime was mixed with sodic waste material, giving a mixture with SAR=27.2 and EC=2.8 dS/m.

After adding EDTA at the rate of 12 g per L of waste material, the SAR fell to 6.2 and EC was 3.0 dS/m. In a companion test, adding calcium carbonate to the soil-waste mixture as well as EDTA did not affect results, indicating that additional Ca was unnecessary even in the absence of lime in the soil. Exchangeable Ca ions on cation exchange sites may become chelated in such cases.

(l) The rate of application of a chelating agent that will produce a required SAR result can be estimated by assuming that Ca is released from a soil in an amount proportional to the rate of agent applied. For example, EDTA and Ca form a 1:1 stoichiometric complex such that 272 g of EDTA (one mole) can release 40 g of calcium when added to soil. Some magnesium is also released, whose amount can be estimated reasonably well by assuming that the ratio of Mg to Ca in a saturated paste of the untreated soil would be maintained. Fair agreement was observed between actual SAR values and those estimated as outlined above; the agreement improved when empirical allowance was made for displacement of exchangeable Na by the extra Ca and Mg.

(m) Preferably, bench-scale tests can be conducted, so as to arrive at suitable rates of chelating agent application that would cause a desirable SAR result while ensuring that EC is kept at a desirable, low level. Such tests can also be used to determine whether supplementing the chelating agent with a Ca or Mg compound would be beneficial.

### SUMMARY

In accordance with the present invention, a method for improving soils or soil-waste mixtures adversely affected by sodium consists of blending them with a chelating agent, at a rate chosen to release sufficient calcium and magnesium in chelated for so as to reduce sodicity to a desirable level, while at the same time thus curbing salinity increase.

### DRAWINGS

Not applicable

### DETAILED DESCRIPTION

### First Embodiment

One embodiment of the invention concerns the amelioration of cropped soils whose high sodicity has been found to hamper cultivation, water infiltration and drainage, with resulting adverse effects on crop yield.

### Operation—First Embodiment

A soluble chelating agent such as malic acid can be added as an aqueous solution, said solution being applied to the surface by existing techniques known in the art, such as infiltration and irrigation. These methods would be suited to treating large areas or whole fields.

Alternatively, for fields where high sodicity was present only in relatively small patches, said agent could be applied in solid form to the surface of an affected area then washed into the soil, either by natural precipitation or by applying irrigation water. This patchwork method of application would of course be more economical than treating an entire field.

The objective in either case would be a gradual improvement of ease of soil cultivation and rate of water infiltration into the soil, as a result of several applications of the chelating agent, with the additional object of improving crop yield.

Naturally-occurring chelating agents are suited to this embodiment of the invention because of their tendency to biodegrade in soil. This, there would be no residue of such agents within a few weeks or months of treatment. This lack of persistence will be an advantage in cases where the intention is to improve the rooting zone of a crop.

### Second Embodiment

Another embodiment of the invention concerns the treatment of sodic material such as drilling waste or other by-product which must be disposed of, for example, either to a landfill or by application to local soil, and which in accordance with published guidelines has to meet certain SAR and EC thresholds in order to be so disposed of.

### Operation—Second Embodiment

This use of the invention concerns treatment of sodic by-product materials before their disposal for example by means of mixing and encapsulation in subsoil (currently permitted under disposal guidelines in western Canada). In such cases a chelating agent such as EDTA, with a persistent effect on the SAR of the treated material, would be preferred in order to provide a long term reduction in SAR after disposal.

Application of a sparingly soluble powder like EDTA is more conveniently done by applying it to the waste material before blending said waste with a receiving soil. It is advantageous to add the powder in this way rather than apply it to the receiving soil first, or to a mixture of the waste and soil, since drilling byproducts often have a slurry-like texture which becomes dry on being mixed with soil, thus making blending with a powder more difficult.

### FIGURES

Not applicable

### CONCLUSION, RAMIFICATIONS AND SCOPE

While the above descriptions contain certain specificities they should be construed as examples of the preferred embodiments of the invention rather than limitations on its scope. Other ramifications and variations are possible within the teachings of the invention.

For example, a chelating agent could be applied either in solid form, aqueous solution, or as a slurry so as to aid admixture, depending on the properties of said agent especially its water solubility.

Other plant-growing media such as composts could be conveniently treated in batches with a chelating agent so as to combat any sodicity.

Sodic subsoil inaccessible from the ground surface could be treated with a chelating agent via tubes, pipes, drilled holes, trenches or the like leading into the subsoil.

Chelating agents could be used either individually or in combination with another such agent, either natural or synthetic, or together with a traditional ameliorant salt containing calcium or magnesium.

Accordingly, the scope of the invention should be determined by the following claims and their legal equivalents, rather than by the examples given above.

### LITERATURE REFERENCES

AEUB 19966 Drilling Waste Management. Guide G 50. Alberta Energy and Utilities Board) Calgary, Alberta, Canada.
Ashworth, J. et al. 1999. A comparison of methods for gypsum requirement of brine-contaminated soils. Canadian Journal of Soil Science 79: 449-455.
Ashworth, J. and Webster, J. 2004. The gypsum requirement of drilling wastes applied to soil. Proceedings of the Alberta Soil Science Workshop 41:61-67.
Ayres, G. H. 1968. (Quantitative Chemical Analysis. 2^{nd} Edition. Harper and Row, New York.
Chaberek, S. and Martell A. E. 1959. “Organic sequestering agents.” Wiley & Sons, New York.
Naidu, R. et al. 1993. Sodicity in South Australia a review. Australian Journal of Soil Research 31: 911-929.
Richards, L. A. 1954. (editor) Handbook 60 of the U.S. Dept of Agriculture: Diagnosis and Improvement of Saline and Alkali Soils.

I claim:

1. A method for treating cropped soil adversely affected by sodium, comprising:
(a) Contacting said soil so as to form a mixture with a chelating agent selected from the group of naturally-occurring acids consisting of citric, tartaric, oxalic, ascorbic, malic, gluconic acid and the like, and
(b) Applying said chelating agent at a rate suited to the sodicity of said soil, and preferably pre-determined by small-scale tests; typically in the range 1-20 tonnes of agent per hectare of ground surface.

2. A method for treating a sodic by-product material such as drilling waste, or a soil used as a receiving medium for said sodic material, comprising:
Contacting said sodic material so as to form a mixture with the acid form of a chelating agent selected from the group of synthetic chemicals known universally by the acronyms EDTA, HEDTA, DTPA, NTA, EHPG and the like, by applying the agent either,
(a) to said sodic material, or to said soil, or
(b) to a mixture of said material with said soil, or
(c) to a fluid used in generating said material, or
(d) at a stage in the process of generating said material;
(e) in any case, at a rate suited to the sodicity of said material, and preferably pre-determined by small-scale tests; typically in the range 1-20 kg per cubic meter of said waste.
Whereby; the adverse properties of said sodium-affected soil or other material that are due to its sodicity are alleviated by using said agents as described in claims 1 and 2 above, without substantially worsening adverse properties of said soil or other material that are due to its salinity.
